(19) United States
(12) Patent Application Publication
(10) Pub. No.: US 2007/0277697 A1
(43) Pub. Date: Dec. 6, 2007

(54) PRODUCT FOR TREATING VEHICLE SURFACES

(76) Inventors: Keri Diamond, Livermore, CA (US); Cheryl H. Rodriquez, Pleasonton, CA (US); Ashot K. Serobian, Martinez, CA (US); Stephanie Farkas Gathman, Midland, MI (US)

Correspondence Address: THE CLOROX COMPANY, P.O. BOX 24305, OAKLAND, CA, 94623-1305, US

(21) Appl. No.: 11/422,517

(22) Filed: Jun. 6, 2006

(51) Int. Cl. C09D 5/20; C09G 1/02

(52) U.S. Cl. 106/3; 106/2

(57) ABSTRACT

A product for treating the surfaces of vehicles comprising a silanol-containing composition used to enhance gloss and aid in protecting substrates. More particularly, a product for treating vehicles comprising silanols and catalysts that cure to form a durable coating when exposed to the moisture in air.

### BACKGROUND

The present invention relates generally to silanol-containing protectant compositions used to enhance gloss and aid in protecting substrates. More particularly, the present invention pertains to products for treating vehicles comprising silanols and catalysts that cure to a dry finish.

Vehicle protectants are known in the art and are applied to the substrate desired to be “protected” such as a tire, car seat, dashboard, arm rest, etc. The protectant may be applied directly onto the surface to be treated, or may be first applied onto a cloth, pad, roller, sponge, or the like. As a result of this application, the substrate is enhanced, cleaned, and/or protected.

The use of automobile protective surface compositions are well known in the prior art and commercially demonstrated by the availability of various products sold under the trademarks SON—OF-A-GUN™ and ARMOR ALL™(trademarks of the Armor All/STP Company). The aforementioned products are well known as providing a silicone-oil based spray-on protectant to provide gloss (an aesthetic appearance property) and a protectant film to rubber polymer, and other surfaces. Representative of the well known use of such protectant products include use on automotive parts such as automobile tires, vinyl tops, vinyl dashboards, vinyl upholstery, rubber sealing strips, rubber and/or polymeric bumpers and the like, as well as usages in the home on synthetic rubbers, wood, painted surfaces, leather and the like.

For example, U.S. Pat. Nos. 3,956,174, and 4,133,921, each disclose preservative compositions comprising an emulsion of at least one water emulsifiable organopolysiloxane fluid having a viscosity of from about 100 to about 10,000 centistokes, and based on the weight of the polysiloxane fluid from about 65% to about 5,000% by weight of water, and from about 15% to about 65% by weight based on the weight of the polysiloxane fluid of at least one water miscible polyol compound. U.S. Pat. No. 4,347,333 discloses an emulsion coating composition (emulsion) containing silicone fluids, a cleaning solvent, water, surfactant and an acrylic polymer which is soluble in the cleaning solvent. The cleaning solvent is present in an amount from about 5-65% by weight if the emulsion is an oil-in-water emulsion and from about 15-90% by weight if the emulsion is a water-in-oil emulsion.

U.S. Pat. No. 5,433,890 discloses protectants containing both an aminofunctional organopolysiloxane and a polydimethylsiloxane, a film forming polymer to increase abrasion resistance, and morpholine, necessary to activate the film forming polymer are disclosed.

Silicones have also been used as water repellant caulking and adhesives, wherein condensation polymerization and other types of reactive chemistries are relied upon to set or harden these caulking and adhesives products for adherence to a desired surface. U.S. Pat. Nos. 6,602,379 and 6,686,301 each disclose adhesive compositions containing aminosilane and organo-functional silanes.

U.S. Pat. No. 5,089,253 assigned to Dow Corning discloses a silanol-end-blocked polydiorganosiloxane fluid catalyzed to retain the curl in hair. U.S. Pat. No. 4,657,967 assigned to Dow Corning discloses room temperature curing compositions containing tetrafunctional ethoxy-ketoximo silane crosslinkers. U.S. Pat. No. 4,600,436 discloses an aminofunctional silicone polish prepared with a polydiorganosiloxane in an aqueous medium in the presence of an emulsifier or mixture of emulsifiers and optionally, a polymerization catalyst.

Additionally, protectants have been designed specifically for use on tires. The tires of automobiles, bicycles and other vehicles collect dust, mud, etc. from the road to become soiled and unsightly. Moreover, as they are used for long periods of time, the tires lose their initial gloss and even if washed free of dirt, soil, etc., they will remain dull and lusterless. Illustrative tire treatment compositions and methods are disclosed in U.S. Pat. No. 4,880,557 wherein a tire lustering and cleansing agent comprises silicone oils, emulsifiers and water. U.S. Pat. No. 5,378,271 discloses silicone based polymers with emulsifiers. U.S. Pat. No. 5,518,533 to Armor All discloses a tire treatment composition comprising a cationic emulsifier, a modified silicone, and a dispersant.

However, while these treating agents impart good gloss and acceptable water repellency to tires, they can be stripped off by rain and wear over time requiring reapplication.

Additionally, treatments with silicone compositions typically impart a wet to the touch or “greasy” feel to the treated substrate. The wet surface can subsequently attract dirt or dust leaving the tire in need of additional cleaning and treatments. For at least the foregoing reasons, there is a need for a durable vehicle treatment product that cures dry to the touch.

It has now been surprisingly discovered that large and small molecular weight silanol end chain organopolysiloxane can be used together in a catalyzed reaction on vehicle surfaces to increase durability, while maintaining a high gloss finish. Larger molecular weight silicone chains are less greasy and significantly improve durability, however, spreadability becomes difficult with increasing molecular weight. The introduction of reactive silicone-based chemistries provides an opportunity to exploit the benefits of high molecular weight silicone polymers while eliminating the need to manipulate large molecules on the surface of the tire. Additionally, reactive chemistries have been found to reduce the “greasy” feel of the finished product on the surface, and minimize “sling” or loss of product due to the movement of a treated surface such as a those on a vehicle, and surfaces such as those with a high amount of movement such as a vehicle tire.

### SUMMARY

The present invention is directed to a product that satisfies these needs and overcomes the above-mentioned disadvantages. The present invention provides a composition, and method of use, which imparts an aesthetically pleasing appearance to substrates, particularly vehicle surfaces such as rubber, glass, vinyl, leather, plastic, cloth, metal, coated metal, or chrome. The shine or gloss of the treated substrate is enhanced, and cures dry to the touch to prevent sling, and improve durability. Additionally, the present invention has a reduced degree of greasiness once dry. A product for treating vehicle surfaces having features of the present invention comprises:
a. a silanol fluid,
b. a catalyst
c. optionally, a solvent
d. optionally, a crosslinking agent, and
e. optionally, a wetting agent.

In accordance with the above objects and those that will be mentioned and will become apparent below, one aspect of the present invention is to provide a durable vehicle surface treatment that cures and adheres to the surface.

Further features and advantages of the present invention will become apparent to those of ordinary skill in the art in view of the reference to the following description and appended claims.

### DETAILED DESCRIPTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

As used herein, “moisture curable” means the catalyzed system is capable of hardening to a rigid or semi-rigid structure on exposure to moisture. Atmospheric moisture means the amount of moisture in the air, or relative humidity.

It must be noted that, as used in this specification and the appended claims, the singular forms “a,” “an” and “the” include plural referents unless the content clearly dictates otherwise. Thus, for example, reference to a “silanol” or a “crosslinking agent” includes two or more such ingredients.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (%) are in weight percent based on 100% of the total composition.

### Silanol Fluid

The compositions of the present invention contain silanol fluids such as silanol end-blocked polyorganosiloxane fluids, and have a viscosity of from about 1 to about 10,000,000 centipoise measured at 25.degree. The silanol end-blocked polyorganosiloxanes useful in the compositions of the present invention are represented by the following:

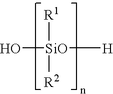

wherein R1 and R 2 are independently selected from hydrogen, alkyl, alkenyl, aryl, and alkylaryl groups having 1 to 22 carbon atoms and organo-modified alkyl and aryl groups such as amino, epoxy, carboxy, or mercapto groups; and n is an integer from about 5 to about 15,000.

The silanol end-blocked polyorganosiloxanes employed in the practice of the present invention may vary from low viscosity fluids to viscous gums. Examples of silanol end-blocked polyorganosiloxanes useful in compositions of this invention include, but are not limited to, the following:

HOMe2SiO(Me2SiO)5SiMe2OH

HOMe2SiO(Me2SiO)15SiMe2OH

HOMe2SiO(Me2SiO)35SiMe2OH

HOMe2SiO(Me2SiO)283SiMe2OH

HOMe2SiO(Me2SiO)539SiMe2OH

HOMe2SiO(Me2SiO)3400SiMe2OH.

Additionally, the composition of the present invention may be comprised of more than one silanol fluid to take advantage of the range of properties attributed to various chain length silanol fluids. Low molecular weight silanol fluids for instance flow and are more easily applied to surfaces and generally have a better aesthetic look with a shiny, glossy finish. High molecular weight silanols are less greasy to the touch, are more durable, and are less likely to be removed from the surface. High molecular weight silanols by themselves, however, may be difficult to apply and manipulate on a vehicle surface. Silanol fluids such as those mentioned above are generally utilized at a concentration of 1 to 99 weight percent. Additional embodiments of the invention utilize a concentration of silanol fluids from about 30 to 50 weight percent.

Examples of high molecular weight silanol fluids useful in the present invention include but are not limited to silanol fluids with a viscosity above 500 cSt but below 10000 cSt. Higher molecular weight silanol fluids can also be used if formulated to the proper flow requirements of the particular product. Low molecular weight silanol fluids useful in the present invention include but are not limited to silanol fluids with a viscosity above 10 cSt but below 500 cSt.

### Catalyst

The composition of the present invention includes a catalyst. Catalysts useful in the present invention include condensation reaction catalysts. More specifically, those that can facilitate a reaction when exposed to atmospheric moisture. In other words, it is strongly desired to develop a moisture curable composition which is excellent in storage stability in the sealed containers, i.e., capable of being stored under constant viscosity for a long period, rapidly curable in the presence of atmospheric moisture, and outstanding in mechanical strength after curing. The quick curing when exposed to the moisture in the air is a particular product benefit because it prevents sling, or loss of product due gravity or the movement of a treated surface such as a tire. The time required for the present compositions to cure depends upon ambient temperature, humidity, the reactivity of the groups in the presence of atmospheric moisture and the type of curing catalyst selected. Preferably, the present invention will cure under a variety of environmental conditions including conditions with higher and lower humidity, such but not limited to as about 0.5% to about 100% RH.

Examples of catalysts useful in the present invention include, metal carboxylates, metal oxides, alkyl metal carboxylates, alkyl metal alkoxides and metal chelates. More specifically, tetraalkyl titanate, tetraalkyl zirconate, dibutyltindiacetate, dibutyltindilaurate, dibutyltin dioctoate, dibutyltin dimalate, stannous octoate, tin octylate, tetrabutyl titanate, dioctyltindilaurate and tetraisopropyltitanate are examples of catalysts that may be used. In one embodiment the catalyst tetrabutyl titanate is used, which is available from E.I. DuPont Nemours & Co., Inc., Wilmington, Del., under the trademark TYZOR® TnBT.

### Additional Ingredients

### Solvent

Optionally, the present invention may include a solvent to improve the coating properties of the composition. Such a solvent should have a boiling point in the range of from 100° C. to 200° C., be capable of dissolving silanol fluids, and be selected appropriately depending on the type and amount of solute used. Solvents useful in the present invention include liquid hydrocarbons and silicone solvents. Additionally, solvents useful in the present invention include toluene, xylene, naphthene, and other aromatic hydrocarbons; 2-pentanone, 4-methyl-2-pentanone, and other ketones; isoparaffin, paraffinic alkanes, normal paraffin and other aliphatic hydrocarbons; butyl acetate, isobutyl acetate, and other esters; hexamethyldisiloxane, octamethyltrisiloxane, and other volatile silicones which may be used singly or as mixed solvents of two or more solvents. Volatility of a substance is determined when it meets the definition according to ASTM D 2369. This testing protocol measures the percentage weight loss after heating in an oven at 100° C. The amount of solvent is from 0 wt % to 99 wt %, and preferably from 30 wt % to 70 wt % relative to the total amount of the finished composition to balance the desired coating qualities with the appropriate viscosity for ease of application.

### Wetting Agent

Optionally, the present invention may include a wetting agent to enhance the ability of a composition to distribute or spread across a surface treated. Wetting agents useful in the present invention include silicone surfactants, organo-modified silicones, polydimethylsiloxane fluids, and silicone polyethers.

Examples of silicone surfactants useful in the present invention include, for example, nonionic silicone-glycol copolymers, such as those available from SILWET (Witco Specialties Group, One American Lane, Greenwich, Conn.), including SILWET L-77 (silicone polyalkylene oxide-modified dimethyl polysiloxane)(CAS: 27306-78-1), SILWET L-7210, L-7220, and L-7230 (CAS: 68937-55-3) and as described in Adjuvants for Agrichemicals Ed. Foy, CRC Press (1992), and nonionic silicone polyethers, such as are available from Dow Corning (Midland, Mich.), such as Sylgard 309 (2-(3-hydroxypropyl) heptamethyltrisiloxane, ethoxylated, acetate).

### Crosslinking Agent

Optionally, the present invention may include a crosslinking agent. Representative organosilicon crosslinking agents which may be employed include vinylmethyldiacetoxysilane, ethyltriacetoxysilane, methyltriacetoxysilane, vinyltriacetoxysilane, silicon tetraacetate, methyltriethoxysilane, methyltrimethoxysilane, dimethyltetramethoxydisiloxane, tetraethoxysilane, tetramethoxysilane, tetrapropoxysilane, bis(n-methylbenzylamido)ethoxy-methylsilane, tris(cyclohexylamino)methylsilane, vinyl tris(isopropenoxy)silane, vinyltris(methylethylketoximine)silane, and methyltris(methylethylketoxime) silane. Additional crosslinking agents include phenyl functionalized silanes, methyl functionalized silanes, organic silicates such as tetraethyl orthosilicate, or combinations thereof. The crosslinking agent is present in an amount of from about 0.1% to about 20% based on the total weight of the composition.

### Additional Adjuncts

The composition of the present invention optionally contains one or more of the following adjuncts: stain and soil repellants, lubricants, odor control agents, perfumes, fragrances and thickeners. Other adjuncts include, but are not limited to, dyes and/or colorants, solubilizing materials, stabilizers, defoamers, preservatives, and other polymers. Thickeners, when used, include, but are not limited to, polyacrylic acid, xanthan gum, calcium carbonate, aluminum oxide, alginates, guar gum, methyl, ethyl, clays, and/or propyl hydroxycelluloses. Defoamers, when used, include, but are not limited to, silicones, aminosilicones, silicone blends, and/or silicone/hydrocarbon blends.

Additionally, the composition may include ingredients or features that optimize the timing of the catalytic reaction. This is often necessary when conditions, such as humidity or temperature are variable, and speed up or slow the reaction making it more difficult to tailor to a specific use. Examples include but are not limited to coating or encapsulating the catalyst and cure accelerators. It may also be necessary to keep the catalyst and the curable composition from coming into contact with one another until cure is desired. One approach is to formulate a two-part system in which the catalyst is in one part and the curable composition is in another part. Two part systems may utilize divided packaging or other features that prevent the mixing of the catalyst with the curable compositions separate until the reaction is needed.

Furthermore, various additives and fillers normally added to vehicle treating materials can be appropriately added to the present composition. Specifically suggested are titanium oxide, ultramarine blue, Prussian blue, zinc white, rouge, chrome yellow, lead white, carbon black, transparent iron oxide, aluminum powder, and other inorganic pigments; azo pigments, triphenylmethane pigments, quinoline pigments, anthraquinone pigments, phthalocyanine pigments, and other organic pigments; rust preventives, UV absorbers, photostabilizers, anti-sagging agents, leveling agents, and other additives; quartz micropowder, calcium micropowder, fumed titanium dioxide, diatomaceous earth, aluminum hydroxide, microparticulate alumina, magnesia, zinc oxide, zinc carbonate and combinations of the above.

### Measurement/Testing

The measurement of drying, curing, or skin-over, is used to determine the amount of time it takes for a composition applied to a surface to reach a non-tacky state. Useful for determining dry, cure, or skin-over time are test protocols CTM 0095 from Dow Corning's corporate test method which uses polyethylene film contact to determine the non-tacky characteristic.

The compositions are spread ⅛+/− 1/32 in. (0.32+/−0.08 cm) thick on a clean, smooth, non-porous surface and exposed to 77+/−2 F (25+/−1 C) and 50+/−4% RH. At intervals of 5 min or less a clean polyethylene strip is set on a fresh surface with a 1 oz (28.3 g) weight and left for 4+/−2 s before removing. The strip is then pulled straight up, from one end, and the time recorded when the strip pulls away cleanly from the sample. Visual inspections of the polyethylene strip determine whether the tested compositions are dry and thus pull away cleanly from the treated surface, or whether the tested compositions stick to the polyethylene strip and thus need additional drying time.

### Areas of Use

The product can be used to treat vehicle surface such as inanimate, vehicle surfaces, including tires, dashboards, leather, windows, walls, and automobiles. Other surfaces include stainless steel, rubber, glass, vinyl, leather, plastic, cloth, metal, coated metal, and chrome. In particular, the present invention can be utilized to treat automotive tires that require quick drying to prevent sling and the desire for consumers to have a glossy finish. Additionally, the product can be applied to a vehicle surface by using a device such as a spray container, pourable container, aerosol container, squeeze container, pen, brush, sponge, roller, cloth, non-woven, moldable foam, syringe, power tool, power sprayer, and combinations thereof. The product can also be contained in a package that keeps the silanol fluid separate from the catalyst until use or immediately before use.

### EXAMPLES

Several specific, non-limiting, examples of products for treating vehicle surfaces in weight percent are as follows. The example compositions, described below, are intended to illustrate the sample compositions that were used to acquire experimental data on the efficacy of the protectant compositions. The compositions of this invention can be prepared by mixing the ingredients employing any suitable mixing equipment. For example one part, moisture curable compositions may be made by mixing together the silanol fluids, solvents, cross-linkers, and wetting agents (when present) and catalyst. Additional adjuncts may be added to the mixture at any desired stage, and this is preferably done as near the end of the mixing procedure as possible. It is, of course, understood that the above procedures are to be carried out in the absence of moisture in order to prevent premature curing of the compositions. This also applies to subsequent storage of the compositions. After mixing, the compositions may be stored under substantially anhydrous conditions, for example in sealed containers, until required for use.

As detailed above, the example formulas below can contain other optional adjuncts, and the protectant compositions may be applied to a surface by other suitable means than spray or aerosol applications. Tables I and II indicate that the product for treating vehicles exhibits improved levels of dry time and cures at different rates depending on the formula and the ratio of high to low molecular weight silanols.

TABLE I

| | | Example | Example |
|---|---|---|---|
| | | A | B |
| Ingredient Detail | Function | Wt % | Wt % |
| LPA-170 | Hydrocarbon | 51.50% | 53.50% |
| | solvent | | |
| 25–50 cSt silanol fluid | Silanol | 30.00% | 20.00% |
| 1500–3000 cSt silanol fluid | Silanol | 10.00% | 20.00% |
| Tyzor ® TnBt | Catalyst | 2.50% | 2.50% |
| DC 309 (by Dow Corning) | Wetting | 1.00% | 1.00% |
| | agent | | |
| DC 6124 (by Dow Corning) | Silane | 5.00% | 3.00% |
| | crosslinker | | |
| | Total Percent | 100.00% | 100.00% |
| | Composition | | |
| | Dry time | >36 hours | 24 hours 45 min. |

TABLE II

| | | Example C | Example D |
|---|---|---|---|
| Ingredient Detail | Function | Wt % | Wt % |
| LPA-170 | Hydrocarbon | 48.50% | 50.50% |
| | solvent | | |
| 35–100 cSt silanol fluid | Silanol | 30.00% | 20.00% |
| 11,000–15,000 cSt silanol | Silanol | 10.00% | 20.00% |
| fluid | | | |
| Tyzor ® TnBt | Catalyst | 2.50% | 2.50% |
| DC 309 (by Dow Corning) | Wetting agent | 1.00% | 1.00% |
| DC Silane Z-6070 ® | Silane | 5.00% | 3.00% |
| (by Dow Corning) | crosslinker | | |
| DC 245 (by Dow Corning) | Silicone | 3.00% | 3.00% |
| | solvent | | |
| | Total Percent | 100.00% | 100.00% |
| | Composition | | |
| | Dry time | < or = 25 | < or = 10 |
| | | minutes | minutes |

The invention will be further illustrated by a consideration of the following examples. All parts and percentages in the examples are on a weight basis unless otherwise stated.

### Example E

### Into a Container were Placed

48.5% hydrocarbon solvent
20% high molecular weight hydroxy functional silanol
20% low molecular weight hydroxy functional silanol
5% phenyl functionalized silane
3% silicone solvent
2.5% moisture activated catalyst
1% silicone wetting agent.

### The contents were mixed until a uniform homogenous solution was obtained.

### Example F

### Into a Container were Placed

53.5% hydrocarbon solvent
20% high molecular weight hydroxy functional silanol
20% low molecular weight hydroxy functional silanol
3% silicone solvent
2.5% moisture activated catalyst
1% silicone wetting agent.

### The contents were mixed until a uniform homogenous solution was obtained.

### Example G

### Into a Container were Placed

48.5% hydrocarbon solvent
20% high molecular weight hydroxy functional silanol
20% low molecular weight hydroxy functional silanol
2.5% phenyl functionalized silane
2.5% methyl functionalized silane
3% silicone solvent
2.5% moisture activated catalyst
1% silicone wetting agent.

### The contents were mixed until a uniform homogenous solution was obtained.

### Example H

### Into a Container were Placed

50.5% hydrocarbon solvent
10% high molecular weight hydroxy functional silanol
30% low molecular weight hydroxy functional silanol
3% phenyl functionalized silane
3% silicone solvent
2.5% moisture activated catalyst
1% silicone wetting agent.

### The contents were mixed until a uniform homogenous solution was obtained.

### Example I

### Into a Container were Placed

48.5% hydrocarbon solvent
10% high molecular weight hydroxy functional silanol
30% low molecular weight hydroxy functional silanol
5% phenyl functionalized silane
3% silicone solvent
2.5% moisture activated catalyst
1% silicone wetting agent.

### The contents were mixed until a uniform homogenous solution was obtained.

### Example J

### Into a Container were Placed

48.5% hydrocarbon solvent
10% high molecular weight hydroxy functional silanol
30% low molecular weight hydroxy functional silanol
2.5% phenyl functionalized silane
2.5% methyl functionalized silane
3% silicone solvent
2.5% moisture activated catalyst
1% silicone wetting agent.

### The contents were mixed until a uniform homogenous solution was obtained.

### Example K

### Into a Container were Placed

48.5% hydrocarbon solvent
20% high molecular weight hydroxy functional silanol
20% low molecular weight hydroxy functional silanol
5% methyl functionalized silane
3% silicone solvent
2.5% moisture activated catalyst
1% silicone wetting agent.

### The contents were mixed until a uniform homogenous solution was obtained.

### Example L

### Into a Container were Placed

48.5% hydrocarbon solvent
10% high molecular weight hydroxy functional silanol
30% low molecular weight hydroxy functional silanol
5% methyl functionalized silane
3% silicone solvent
2.5% moisture activated catalyst
1% silicone wetting agent.

### The contents were mixed until a uniform homogenous solution was obtained.

### Example M

### Into a Container were Placed

49.5% hydrocarbon solvent
30% high molecular weight hydroxy functional silanol
10% low molecular weight hydroxy functional silanol
5% methyl functionalized silane
3% silicone solvent
2.5% moisture activated catalyst

### The contents were mixed until a uniform homogenous solution was obtained.

### Example N

### Into a Container were Placed

52.5% linear paraffinic alkane solvent
25% low molecular weight hydroxy functional silanol
15% high molecular weight hydroxy functional silanol
1% phenyl functionalized silane
3% methyl functionalized silane
2.5% moisture activated catalyst
1% silicone wetting agent

### The contents were mixed until a uniform homogenous solution was obtained.

### Example O

### Into a Container were Placed

41% high molecular weight hydroxy functional silanol
41% low molecular weight hydroxy functional silanol
4% phenyl functionalized silane
4% methyl functionalized silane
5% silicone solvent
3% moisture activated catalyst
2% silicone wetting agent.

### The contents were mixed until a uniform homogenous solution was obtained.

### Example P

### Into a Container were Placed

56.5% hydrocarbon solvent
20% low molecular weight hydroxy functional silanol
20% high molecular weight hydroxy functional silanol
2.5% moisture activated catalyst
1% silicone wetting agent.

### The contents were mixed until a uniform homogenous solution was obtained.

Although the present invention has been described in considerable detail with reference to certain preferred versions thereof, other versions are possible. For example a solvent-less system, a single silanol system, a multiple silanol system, or an aqueous based emulsion. Therefore, the spirit and scope of the appended claims should not be limited to the description of the embodied versions herein.

We claim:

1. A product for treating vehicle surfaces, the product comprising:
a. a low molecular weight silanol fluid,
b. a high molecular weight silanol fluid,
c. a catalyst,
d. optionally, solvent,
e. optionally, a crosslinking agent, and
f. optionally, a wetting agent.

2. The product of claim 1 wherein the viscosity of the low molecular weight silanol fluid is between 10 to below about 500 cSt, and the viscosity of the high molecular weight silanol fluid is between above about 500 to 25000 cSt.

3. The product of claim 1 wherein the product is moisture curable and cures on contact with moisture in the air in less than 20 minutes.

4. The product of claim 1 wherein the product is moisture curable and cures on contact with moisture in the air in less than 10 minutes.

5. The product of claim 1 wherein the catalyst is selected from a group consisting of: metal carboxylates, alkyl metal carboxylates, alkyl metal oxides, organo metallics, and metal chelates, and combinations thereof.

6. The product of claim 5 wherein the catalyst is tetrabutyltitanate.

7. The product of claim 1 wherein the solvent is selected from a group consisting of liquid hydrocarbons and silicone solvents or combinations thereof.

8. The product of claim 7 wherein the solvent is a paraffinic alkane with a volatile content of greater than 50%.

9. The product of claim 1 wherein the wetting agent is selected from the group consisting: of silicone surfactants, organo-modified silicones, polydimethylsiloxane fluids, and combinations thereof.

10. The product of claim 1 wherein the wetting agent contains a silicone polyether.

11. The product of claim 1 wherein the crosslinking agent is selected from a group consisting of: silane monomers, silicates, short chain siloxanes, and combinations thereof.

12. The product of claim 1 wherein the crosslinking agent is a phenyl functionalized silane, methyl functionalized silane, or a mixture of phenyl functionalized silanes and methyl functionalized silanes.

13. The product of claim 1 further including at least one ingredient selected from the group consisting: of fragrances, thickeners, colorants, propellants, stabilizers, and combinations thereof.

14. The product of claim 1 wherein the vehicle surface is selected from a group consisting of rubber, glass, vinyl, leather, plastic, cloth, metal, coated metal, or chrome.

15. The product of claim 1 wherein the vehicle surface is a tire.

16. The product of claim 1 further including an application device selected from the group consisting of a spray container, pourable container, aerosol container, squeeze container, pen, brush, sponge, roller, cloth, non-woven, moldable foam, syringe, power tool, power sprayer, and combinations thereof.

17. A product for treating vehicle surfaces, the product comprising:
a. a silanol fluid,
b. a catalyst,
c. optionally, a solvent,
d. optionally, a crosslinking agent, and
e. optionally, a wetting agent.

18. A kit for treating at least one surface of a vehicle, the kit comprising,
a. a product, said product further comprising,
i. a silanol fluid,
ii. a catalyst,
iii. optionally, a solvent,
iv. optionally, a crosslinking agent, and
v. optionally, a wetting agent,
b. instructions for using the product, the instructions being enclosed with or on a container enclosing the kit, wherein the instructions for using the product include a curing step.

19. The kit of claim 18 wherein the product is contained in a package that keeps the silanol fluid separate from the catalyst until use or immediately before use.

20. The product of claim 1 wherein the viscosity is between about 10 to 25000 cSt.
